(19) United States
(12) Patent Application Publication
(10) Pub. No.: US 2016/0070285 A1
(43) Pub. Date: Mar. 10, 2016

(54) Systems and Methods for Managing Energy Usage Using Disaggregated Energy Data

(71) Applicants: Abhay Gupta, Cupertino, CA (US); Vivek Garud, Cupertino, CA (US); Kobi Eisenberg, Sunnyvale, CA (US)

(72) Inventors: Abhay Gupta, Cupertino, CA (US); Vivek Garud, Cupertino, CA (US); Kobi Eisenberg, Sunnyvale, CA (US)

(21) Appl. No.: 14/844,906

(22) Filed: Sep. 3, 2015

Related U.S. Application Data
(60) Provisional application No. 62/045,646, filed on Sep. 4, 2014.

(51) Int. Cl. G05F 1/66; G05B 15/02

(52) U.S. Cl. CPC G05F 1/66; G05B 15/02

(57) ABSTRACT

The present invention is generally directed to systems and methods for managing energy usage in a household. Exemplary methods may include receiving, using an energy management device, entire energy profile data associated with the household generated in a first time period; disaggregating, using the energy management device, the entire energy profile data to determine energy usage associated with one or more appliances used in the household; retrieving, using the energy management device, energy usage of the household generated in a second time period; detecting, using the energy management device, one or more deviations in the disaggregated energy data generated in the first time period based on the energy data of the household generated in the second time period; and identifying, using the energy management device, one or more causes of the one or more deviations.

### RELATED APPLICATIONS

This application claims the benefit of U.S. Provisional Application No. 62/045,646 filed on Sep. 4, 2014, which is incorporated herein by reference in its entirety.

### BACKGROUND

The present subject matter described herein, in general, relates to managing energy usage, and more particularly but not exclusively, to identifying one or more causes of the deviations in the disaggregated energy data between two time periods.

Customer service and satisfaction is an essential part of utility (electric, water, etc.) industries' business. For the energy supply industry in particular, utility companies and customers routinely interact for many reasons including: to resolve high bill disputes, to notify customers of new incentive or rebate programs, to initiate or cancel service, to report outages, to ask general inquiries, etc. However, these interactions between utility company. Customer Service Representatives (CSRs) and customers are for the most part uninformed. Customer Service Representatives have little to no visibility as to what a unique energy usage pattern of an individual customer means. If CSRs did in fact have access to some of the information that can be derived from the energy consumption data, these conversations would become highly informed, resulting in the easier and cheaper resolution of problems such as: high bill disputes and questions such as “Why is my bill so high lately”? Furthermore, if a user had means to identify the root cause for a high bill such user may not even need to call the utility to understand what caused the increase in usage, and how to take mitigating actions.

Non-Intrusive Load Monitoring (NILM) (also known as energy disaggregation) has been a topic of research for over 20 years. NILM enables the breakdown of electricity usage for a property without entering the property or applying any sub-metering devices on the individual appliances/devices/loads inside the property. The basic NILM process may involve generating and using appliance load signatures to extract energy consumption of individual loads from the whole house load profile data.

One of the common applications of Energy Disaggregation, published in numerous articles and patents, is its use for making consumer aware of their energy spending breakdown and identifying appliance specific inefficiencies. However, many customers may ignore such information unless or until there is a problem—such as a billing dispute or an unanticipated increase in spending or cost.

Accordingly, it is desirable to provide to customer service representatives and user information regarding specific energy usage of customers. Customer service representatives may then be empowered to not only listen to a customer's complaint, but also explain the usage behind any increases in spending or cost, as well as propose mitigating behaviours or applicable programs that may assist the customer in reducing their usage or the cost of their usage. It is further desirable to provide to a user means to identify one or more root causes for a high energy usage bill, such that the user may not even need to call the utility to understand what caused the increase in usage, and how to take mitigating actions.

In accordance with some embodiments of the present invention, systems and methods for providing such disaggregation data and other analytics to CSRs are provided herein. Such data and analytics may give CSRs personalized and specific insights into an energy usage pattern of a specific customer. Such information may then be used to provide uniquely tailored customer service. In addition to providing information to keep a utility's customer base more content, providing CSRs with such data and analytics may also reduce the length and quantity of customer service interactions, thereby saving the utility company time and money.

### SUMMARY

Aspects in accordance with some embodiments of the present invention may include a method for managing energy usage in a household, the method comprising receiving, using an energy management device, entire energy profile data associated with the household generated in a first time period; disaggregating, using the energy management device, the entire energy profile data to determine energy usage associated with one or more appliances used in the household; retrieving, using the energy management device, energy usage of the household generated in a second time period; detecting, using the energy management device, one or more deviations in the disaggregated energy data generated in the first time period based on the energy data of the household generated in the second time period; and identifying, using the energy management device, one or more causes of the one or more deviations.

Other aspects in accordance with some embodiments of the present invention may include an energy management device comprising one or more hardware processors; a memory coupled to the one or more hardware processors storing instructions, that when executed by the one or more hardware processors, causes the one or more hardware processors to perform operations comprising: receiving, using an energy management device, entire energy profile data associated with the household generated in a first time period; disaggregating, using the energy management device, the entire energy profile data to determine energy usage associated with one or more appliances used in the household; retrieving, using the energy management device, energy usage of the household generated in a second time period; detecting, using the energy management device, one or more deviations in the disaggregated energy data generated in the first time period based on the energy data of the household generated in the second time period; and identifying, using the energy management device, one or more causes of the one or more deviations.

The foregoing summary is only illustrative in nature and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment in which an energy utility entity interacts with various users in accordance with some embodiments of the present invention.

FIG. 2 illustrates an exemplary environment in which an energy managing device interacts with various entities in accordance with some embodiments of the present invention.

FIG. 3 is a flowchart of an exemplary method for identifying the root cause of high energy usage, in accordance with some embodiments of the present invention.

FIG. 4 depicts an exemplary interface, or dashboard, showing cost and usage differences for different periods, in accordance with some embodiments of the present invention.

FIG. 5 illustrates an exemplary display or interface, in accordance with some embodiments of the present invention.

FIG. 6 illustrates an exemplary display or interface, in accordance with some embodiments of the present invention.

FIG. 7 illustrates an exemplary display or interface, in accordance with some embodiments of the present invention.

FIG. 8 illustrates an exemplary display or interface, in accordance with some embodiments of the present invention.

FIG. 9 illustrates an exemplary display or interface, in accordance with some embodiments of the present invention.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are directed to method, computer readable medium, and device for managing energy usage in a household. Entire energy profile data associated with the household generated in a first time period is received. Further, the entire energy profile data is analyzed to generate disaggregated energy data regarding the energy usage associated with one or more appliances being used in the at least one household. Then, energy usage of the household generated in a second time period is retrieved. Further, one or more deviations in the disaggregated energy data generated in the first time period is detected based on the disaggregated energy data of the household generated in the second time period. Further, the one or more causes of the one or more deviations may be identified based on at least one of: change in energy usage rate structure, change in one or more energy tier limits.

In accordance with some embodiments of the present disclosure, methods and devices may be capable of communicating directly with individual users regarding energy usage data. As a non-limiting example, devices and methods in accordance with the present invention may query the database 132 or data store that may comprise energy usage data (e.g. GreenButton or AMI interval data) and may then communicate over a public, private, or semi-private network (such as the Internet) directly or indirectly with a smart meter, and communicate with a Home Area Network (HAN) device.

Customer energy usage data may be thereby obtained, and analytics may be performed on the usage data to disaggregate the energy usage into component parts. Such information may then be communicated to a third party. Note that while the present disclosure speaks about a customer service representative of a utility, it is contemplated that a utility may contract or subcontract out its customer service division, and accordingly a third party that is unrelated to the utility may receive the data in order to answer questions and interact with the public on behalf of the utility.

Note that systems in accordance with some embodiments of the present invention may analyze the energy usage data and perform disaggregation itself, or may receive disaggregation results from a separate processor or system. The energy disaggregation results may determine unique signatures of appliances and/or devices in the specific customer home that may be consuming or producing energy. A customer service representative may receive both raw data and calculated analytics directed to such disaggregation.

Such information may assist a customer service representative in solving customer problems, concerns, questions, and disputes as relating to a high utility bill. This may assist a representative in effectively and efficiently addressing bill disputes, common customer questions, etc. For example, in accordance with some embodiments of the present invention, the system may preemptively determine or debug a primary reason for an increase in a customer's spending, based upon analysis of the customer's appliance-level usage. The system may present such information to a customer service representative, as well as mitigating recommendations to the representative to convey to the customer. Such information may assuage the customer's concerns and may cause the customer to believe that the utility is oriented with the customer in a cooperative endeavor to reduce usage and costs. For example, if a large percentage of a customer's whole-house energy consumption is determined to stem from frequent laundry usage, the customer service representative may be so informed and in turn inform the customer. Mitigating behaviors may be discussed, for example running fewer but larger loads, or waiting until after peak hours to run laundry. Similarly, it may be determined from the disaggregated data that the customer's laundry appliances are old or inefficient, and a customer service representative may inform a customer that upgrading his or her laundry appliances may save a certain amount of money per month.

In accordance with some embodiments of the present invention, a customer may not need to interact with a customer service representative or agent. For example, a customer may be enabled to determine one or more root causes of higher bills using a program, application, or process. In accordance with some embodiments of the present invention, an application or app may be used on a customer's mobile device. The app may guide the customer through a flow or analysis of the bill and its potential causes, until one or more root causes are determined. Note that the term “root cause” is used to indicate a factor that is substantially contributing to the increased bill. Such program, application, or app may also be termed a “virtual agent.”

Note that the “virtual agent” may provide such analysis and results either directly to a customer (for example, through an application as discussed above), or to a customer service representative, who may walk the customer through the analysis, and discuss causes and potential future mitigating behaviors.

In this manner, when a customer calls a customer service representative with a problem or complaint (typically high bills), the customer service representative may be empowered with (i) specific information regarding the customer's usage; and (ii) specific recommendations contoured to the customer's usage patterns regarding how to decrease costs.

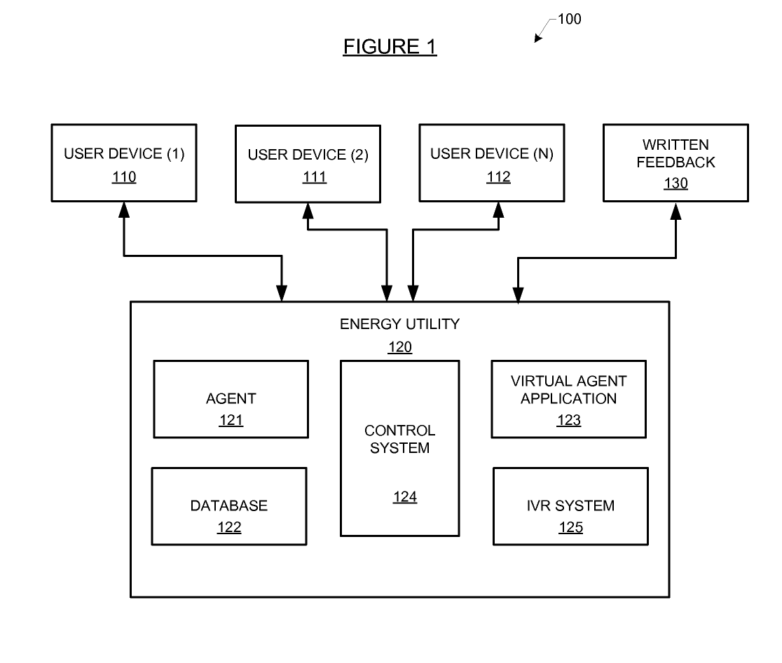

FIG. 1 illustrates an environment 100 in which a utility system 120 may interact with various customer devices 110, 111, 112, in accordance with some embodiments of the present invention. The utility system 120 may interact with various customers that receive energy utility services from the utility associated with the utility system 120. For purposes of this disclosure, a customer may include a single user who receives energy services from the energy utility. However, it should be understood that a customer may also comprise an organization, a company, or a household that interacts with the energy utility. In general, customers have to pay the energy bills, for example every month, depending on bill cycle. At times a customer may receive a bill that the customer may regard as high. Such belief that a bill is high may be based, for example, on deviations between the energy bill in question and historical patterns of the energy usage and cost for the customer. In accordance with some embodiments of the present invention, the utility may provide various manners of communication with the customer for discussion and/or information provision associated with the present bill, or past or future energy usage

In accordance with some embodiments, the utility system 120 may interact with various customer devices 110, 111, 112. Devices 110, 111, 112 may comprise any device capable of conducting communications with the utility system 120. For example, devices 110, 111, 112 may comprise a mobile device, a handheld device, a tablet, a desktop computer, a workstation, a laptop, or a tablet personal computer, or any other electronic device that is capable of conducting communications with the utility system 120. Communications with the utility system may comprise audio and/or video calling, interacting with an interactive voice response (IVR) response system, sending text messages (e.g. short messages system (SMS) messages or mobile message system (MMS)), operating internet browsing functionality, sending electronic mail, and/or providing inputs to a website associated with the energy utility.

Note that in addition to electronic communication, it is also contemplated that a customer may provide written feedback to utility system 120. Such written feedback may, for example, comprise a written communication included with or appended to a bill payment. For example, a customer with a perceived high bill may include a communication (which may be a form provided by the utility) to the utility requesting further information and/or actions that may be taken to mitigate or decrease future energy usage and/or costs.

In general, the utility system 120 may comprise one or more agents 121, one or more databases or data stores 122, a virtual agent application 123, a control system 124, and/or an interactive voice response system 125. Agents 121 may be agents of the utility who have access to customer bills and usage patterns in order to discuss the same with customers and offer various options and/or suggestions to mitigate future usage and/or reduce costs. In accordance with some embodiments of the present invention, agents 121 may guide a customer as to why there are deviations in the current energy bill. Such agents may, for example, communicate with customers via online or electronic chat rooms, text messages, video chats, voice calls (over traditional telephone networks or via internet communications utilizing voice-over-internet-protocol).

Either in addition to agents 121, or in lieu of agents 121, the utility system 120 may comprise an interactive voice response (IVR) system 125. IVR system 125 may interact with customer and/or customer devices to provide various information regarding the customer's bill, energy usage, recommendations, etc. Note that in accordance with some embodiments, a customer may first interact with an IVR system 125 in order to provide information to agent 121, such that when agent 121 and customer interact, agent 121 has information necessary to effectuate a productive, meaningful conversation.

Database 122 may comprise profile energy data associated with a customer. Energy data may be stored in an aggregated or disaggregated format. Database 122 may further comprise past usage trends, historical usage and/or costs associated with a customer, various rebate or cost saving programs, and/or various billing plans.

Additionally, the utility system 120 may include a control system 124 that may control any processing operations performed by the utility system. For example, control system 124 may perform processing activities such as but not limited to processing an entire household energy data to provide disaggregated energy data associated with one or more appliances.

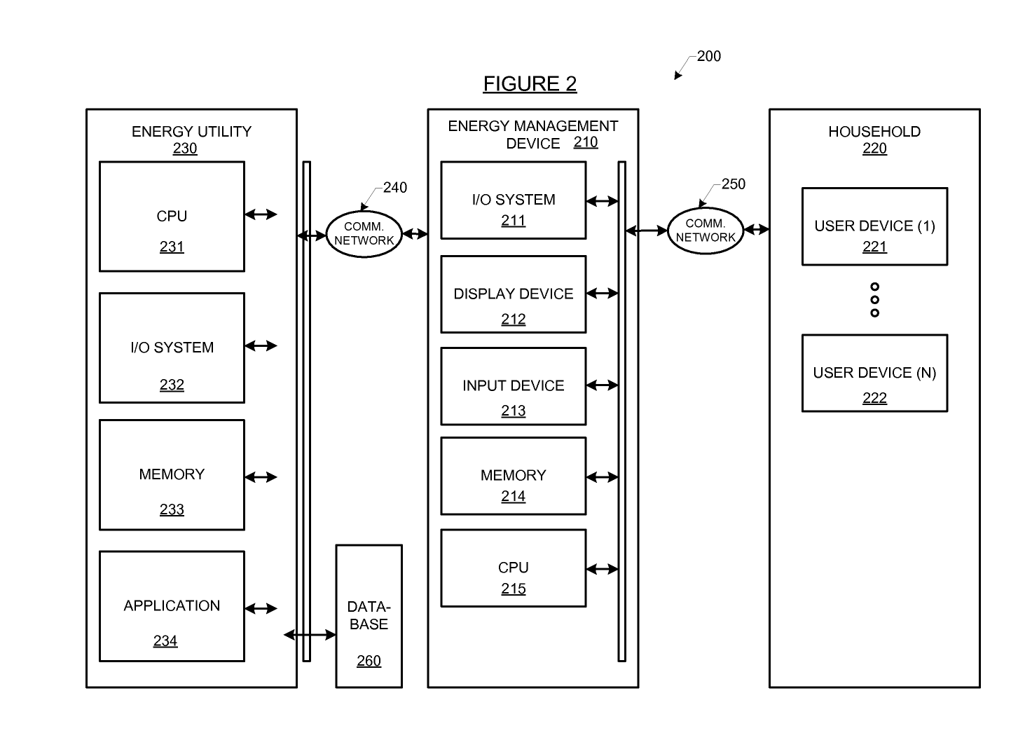

Referring to FIG. 2, in accordance with some embodiments of the present invention, an exemplary environment 200 for managing the energy usage in a household will be discussed. In general, exemplary environment 200 may comprise an energy management device 210 in communication with energy utility 230. The energy management device 210 may communicate with the energy utility 230 via one or more communication networks 240. Note that it is also contemplated that the energy management device 210 may interact with customer devices 221, 222 using a communication network 250 or using other methods or techniques. For example, it is contemplated that the energy management device 210 may interact with the customer devices 221, 222 and a home area network (HAN) (not illustrated) within a specific household 220. Communication networks 240, 250 may include the internet, local area networks (LAN), wide area network (WAN), virtual private networks (VPN), 3G technologies, GPRS, and/or EDGE technologies, although the communication networks 240, 250 may comprise other types and numbers of networks and topologies.

Note that while not shown, the exemplary environment 200 may include additional components, such as but not limited to routers, switches and other devices which are well known to those of ordinary skill in the art and thus will not be described here.

In general, energy management device 210 may facilitate management of energy usage within environment 200 as illustrated and described with the examples herein, although the energy management device 210 may also perform other types and numbers of functions and operate in other types of networks.

Energy management device 210 may comprise various components. Such components may include some or all of: an input/output (I/O) system 211, a display device 212, an input device 213, a memory 214, and/or a central processing unit (CPU) 215. Such components may be connected or in communication with each other through a bus 216. Although it is contemplated that bus 216 may comprise a hyper-transport bus, other bus types and/or links may be used, such as but not limited to a PCI (peripheral component interconnect) system. Note that the energy management device 210 may also comprise other types and numbers of elements in various configurations. Each component is discussed below.

The I/O system 211 in the energy management device 210 may be used to operatively couple and communicate between the energy management device 210 and the customer devices 221, 222, which may be coupled together or in selective communication via communication network 250. The I/O system 211 may work in connection with display device 212 and input device 213 to provide for customer interaction with the energy management device 210.

The display device 212 may enable a customer to interact with the energy management device 210, such as to view information, input information, configure the device, program the device, and/or operate the device. By way of example only, the display device 212 may include one or more of a CRT, LED monitor, LCD monitor, or touch screen display technology although other types and numbers of display devices may be used.

Energy management device 210 may also include an input device 213 that may, for example, enable a customer, to interact with energy management device 210, such as to input data, view data, configure the device, program the device, and/or operate the device. By way of example only, input device 213 may include one or more of a touch screen, keyboard and/or a computer mouse.

The memory 214 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. In accordance with some embodiments of the present invention, memory 214 may store one or more programmed instructions such that the CPU 215 may execute the program, processes and/or methods.

CPU 215 may comprise one or more one or more processing cores, such as AMD® or Intel® processors, and may be configured to execute one or more computer-executable instructions stored in a memory 214, although it is contemplated that the CPU 216 may also execute other types and numbers of instructions and perform other types and numbers of operations. Note that it is contemplated that in accordance with some embodiments of the present invention, the energy management device may be disposed at the energy utility 230.

The exemplary environment 200 may further comprise a specific household 220, which may include or comprise a plurality of customer devices 221, 222, disposed in a household 220. Energy management device 210 and the customer devices 221, 222 within a specific household 220 may be in selective communication via communication network 250. Note that the specific household 220 may include solar generation devices or an energy storage system. Energy input from the solar generation device or energy drawn from an energy storage system must be considered when performing appliance level disaggregation, and further may be considered when understanding fluctuations in energy usage and associated costs, as discussed below.

Energy utility 230 may be in selective communication with energy management device 210 via communication network 240. Communication network 240 may comprise any sort of network or connection, similar to as discussed above with regard to communication network 250. Energy utility 230 may include a central processing unit (CPU) or processor 231, an input/output (I/O) system 232, a memory 233, and an application that may operate as an interface system 234. Such components may be coupled together by a bus or other link, although other numbers and types of network devices could be used.

Energy utility 230 may also further comprise, or have access to, database 260. Database 260 may comprise one or more data stores, and may comprise information such as, but not limited to, various pricing structures for specific customers, entire energy profiles of a customer (i.e., aggregated data), which may be received, for example, from a Smart Meter, disaggregated data, and/or historical patterns of energy use and/or associated costs for specific customers.

Although the exemplary environment 200 includes energy management device 210, a specific household 220 with multiple customer devices 221, 222, and energy utility 230 as described and illustrated herein, other types and numbers of systems, devices in other topologies may be used. It is to be understood that the systems of the examples described herein are for exemplary purposes, as many variations of the specific hardware and software used to implement the examples are possible, as will be appreciated by those skilled in the relevant art(s).

Various exemplary methods and processes for facilitating energy management in a household will now be described. Note that the order of the steps illustrated is exemplary and not to be construed as limiting. The exemplary method illustrates an analysis of a high energy bill analysis, and tries to identify one or more causes. In other words, such methods attempt to account for deviations in the disaggregated energy data for a specific period (such as a month or a billing cycle) as compared to the disaggregated energy data for the previous months. In general, such an analysis may be premised upon one or more assumptions, including but not limited to, that the high cost is due to increased usage, change in rate plan, weather, parameters associated with the one more appliances, and/or time of use. A customer may be guided through an analysis by an agent (or through the use of a virtual agent, this is by using a program, application, or app that walks the customer through the analysis without the involvement of a customer service representative) using a customer device. At the utility, a customer service representative, or agent, may view also view an analysis so that the representative or agent may be well informed and in a better position to explain increased costs—and actions that may be taken to mitigate costs or reduce usage.

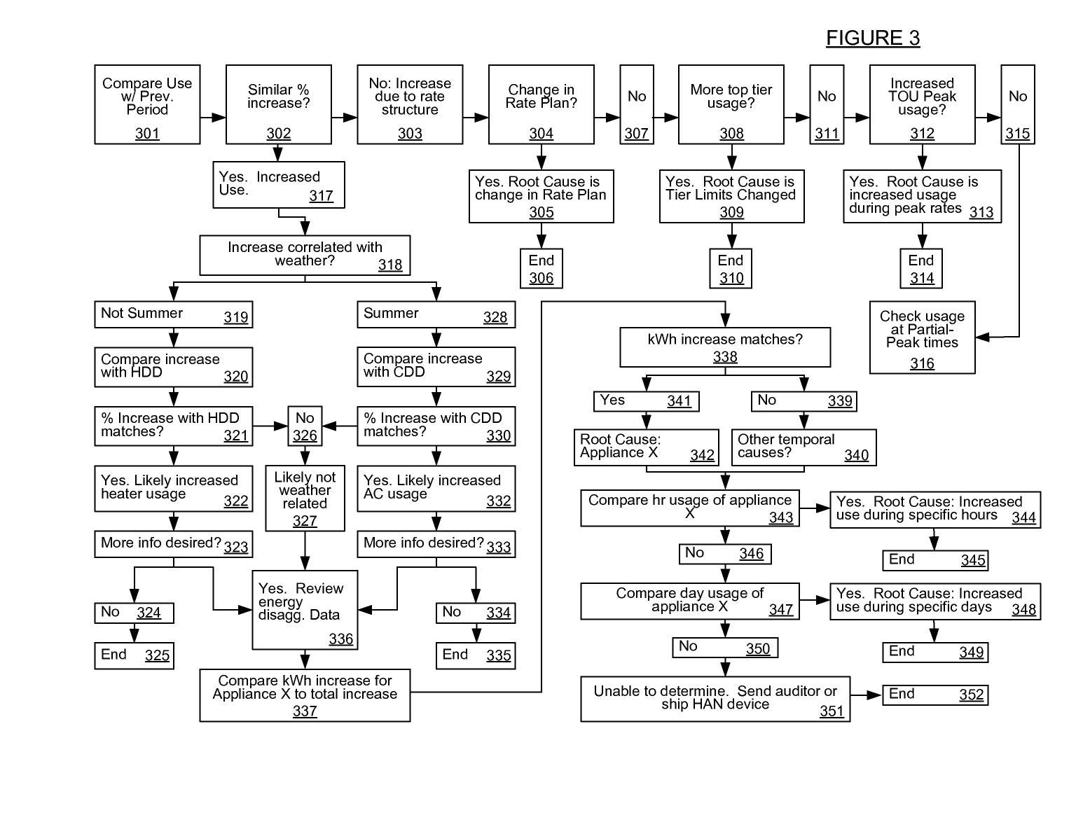

With reference to FIG. 3, an exemplary method 300 in accordance with some embodiments of the present invention will now be discussed. At step 301 the energy units kWh consumed in the current period may be compared against the last or previous periods, and a percentage increase may be determined.

The source of energy units consumed in the current period (for example, the current month or last billed month) and the last period (for example, the previous month, or previously billed month) may be determined via a customer in-home device, such as a programmable communicating thermostat, a Smart Meter, or a home area network enabled device. Note a comparison to any historical period may also be made. Sources may also include CT clamps, IR sensors, and/or AMI interfaces. Additional sources may be non-electric (such as real estate information, tax data (regarding square footage, etc.), weather data, various rebate programs, a database or data store of potential mitigating behaviours, etc.

At step 302, it is determined whether the percentage increase in the energy units and the percentage increase in the energy cost are same or substantially the same (or at least correlated). If the increase in cost and energy units is not the same at 303, the process may advance to step 304. This lack of correlation between increased costs and energy usage amounts may indicate a change in billing structure and/or applicable rates. At step 304 it may be determined if there has been a chance in the customer's rate plan. If there has been a change, at 305 the root cause of the increased bill may be determined to be the change in rate plans. The process may subsequently end at 306.

However, if it is determined that there has not been a change in rate plan at 307, the process may determine if there has been increased usage in either top tiers or peak rates under any applicable time of use (TOU) rate plans. At 308 the system may determine if there has been any increased top tier usage compared to the previous period. If it is determined that there has been increased top tier usage, then at 309 the root cause may be determined to be changes in the tier limits of the customer's applicable rate plan. The process may subsequently end at 310.

If it is determined that there has not been any increase in top tier usage at 311, then it may be determined at 312 if there has been any increase in usage during peak periods based upon the customer's applicable TOU rate plan. If there has been increased usage during peak times, then the root cause may be determined at 313 to be increased usage during peak rates. The process may subsequently end at 314.

If it is determined at 315 that there has not been any increased usage during peak periods, the system may determine if there has been any increased usage in partial-peak periods, or any other usage that while not quantitatively increased, has occurred during times of increased rates and/or associated costs.

With continued reference to FIG. 3, returning to step 302 it may be determined if the percentage increase in energy units used and the percentage increase in energy cost are the same or substantially the same. If it is determined that such increases match (or are positively correlated) at 317, then at step 318 it may be determined if the increase in costs correlates to changes in weather conditions.

It may initially be determined whether or not it is summer. The season may be a primary indicator that increases in costs may be due to air conditioning (AC) or heating devices. In order to provide for an expedited process, based on the season either AC or heater may be used as a starting point.

At 319 it may be determined that it is not summer (i.e., that AC usage is unlikely attributable to the increased cost). At 320 the increase in kWh may be compared with the recorded increase in heating degree days (HDD). “Heating degree days”, or “HDD”, are a measure of how much (in degrees), and for how long (in days), outside air temperature was lower than a specific “base temperature” (or “balance point”). They are used for calculations relating to the energy consumption required to heat buildings. If there is a match or correlation at 321 between the increase in energy usage and the increase in HDD, then at 323 it may be determined that the increased costs are likely attributable to increased heater usage. A customer may be queried if he or she desires additional information at 323. If the customer does not request additional information at 324, the process may terminate at 325.

At 326 it may be determined that the increase in energy usage does not match or correlate with any increase in HDD. At 327 the system may accordingly determine that the increase in usage is unlikely related to the weather.

With renewed reference to step 318, it may be determined at 328 that the present season is summer, and at 329 the increase in energy usage may be compared with increases in cooling degree days (CDD) at 330. “Cooling degree days”, or “CDD”, are a measure of how much (in degrees), and for how long (in days), outside air temperature was higher than a specific base temperature. They are used for calculations relating to the energy consumption required to cool buildings. If the increase does not match or correlate with the increase in the number of CDD at 326, then the process may continue to step 327 where again it may determine that the increase in usage is unlikely related to the weather.

If it is determined at step 332 that the increase in usage and CDD match or correlate, then it may be determined that the increased costs are likely attributable to increased AC usage. A customer may be queried if he or she desires additional information at 333. If the customer does not request additional information at 334, the process may terminate at 335.

If it is determined that the increase in usage is not weather-related, or if the customer desires additional information regarding increased AC or heater usage, then at 336 disaggregated energy data may be reviewed. If the customer has requested information regarding the AC or heater, the energy usage for the AC or heater may be further analyzed or processed. Alternatively, the system (or agent) may step through individual appliance loads to determine if any specific appliance may be responsible for the increase in usage.

At 337, the increase in kWh usage may be compared to an increase of kWh determined through disaggregation to be attributable to a specific appliance. It may then be determined if the increases match (or substantially correlate) at 338. If there is no match or correlation, at 339 the system may look for other temporal causes at 340.

If there is a match or correlation at 341, then the root cause of the increase in the customer's bill may be determined at 342 to be attributable to usage of a specific appliance.

If the customer requests additional information regarding the identified appliance, or if the system is looking for other temporal causes of increased usage, the process may continue to step 343, where the hour of usage of a specific appliance may be compared with past use. For example, hour of day usage of the appliance for the current period may be compared against the previous period. At 344 it may be determined the root cause of increased costs may be that in the period at issue, the appliance use was increased during specific hours or a time band. Subsequently, the process may end at 345.

At 346 it may be determined that the hours of appliance usage were not different than previous periods. At 347 the days of use of the specific appliance may then be compared with the previous period (or a different period). For example energy usage over days of the period (i.e. billing cycle) may be reviewed to identify any days where usage was high. If the days of use differ from the previous period, then the root cause may be determined at 348 to be high use of the specific appliance on specific days. The process may subsequently end at 349.

If it is determined at 350 that there is no substantial or relevant difference in days of use of the specific appliance, then at 351 the system may be unable to determine the cause of increased usage. Accordingly, the system may trigger or request an auditor be sent to the customer, or alternatively that a device be locally installed at the customer's home—such as a home area network (HAN) device in order to obtain additional information.

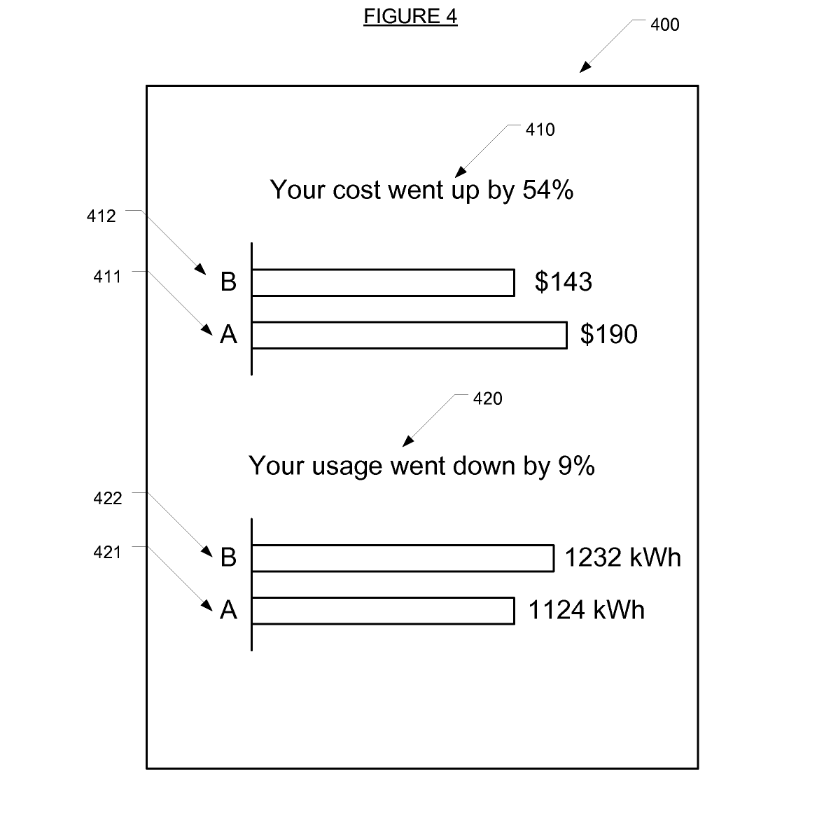

FIGS. 4-9 depict exemplary interfaces, displays, or dashboards showing appliance level energy disaggregation results that may be helpful in understanding or explaining changes in energy usage and/or costs compared with a previous or different period. In general, FIGS. 4-9 compare two billing periods indicated as “A” and “B.” Period “A” is the current period (or the one at issue), while period “B” is the previous period or a period used for comparative purposes. For example, period A may be an August billing cycle. Period B may be the preceding July billing cycle, or in some embodiments period B may be the August billing cycle of the previous year. Note that the information presented in FIGS. 4-9 may be provided both to the customer and to the agent or customer service representative so that both parties are educated in order to make can make informed decisions regarding the high energy bill.

In FIG. 4, an example of a widget 400 provided to the customer and customer service representative or agent is illustrated. Differences in energy usage (in %) with the difference in energy cost (also in %) for the billing cycles A and B may be compared. If the usage and cost increased by the same %, it is likely that the reason for the high bill may be related to usage. Otherwise, if usage % delta is less than cost % delta, it is likely that the reason for the high bill may be related to a change in rate or change in the time of usage. This information may be helpful to initiate an analysis followed up by appliance disaggregation analysis, weather analysis, time of use analysis etc. as explained in conjunction with FIG. 3.

At 410 the customer may be informed that their costs went up by a certain amount (i.e., “Your cost went up by 54%”). This may be graphically presented by comparing Period A 411 with Period B 412, showing an increase from $143 for Period A to $190 for Period B.

At 420 it may also be seen that the customer's actual energy usage decreased (i.e., “Your usage went down by 9%”). Again, this may be graphically presented by comparing Period A 421, which used 1124 kWh with Period B 422, in which 1232 kWh were used.

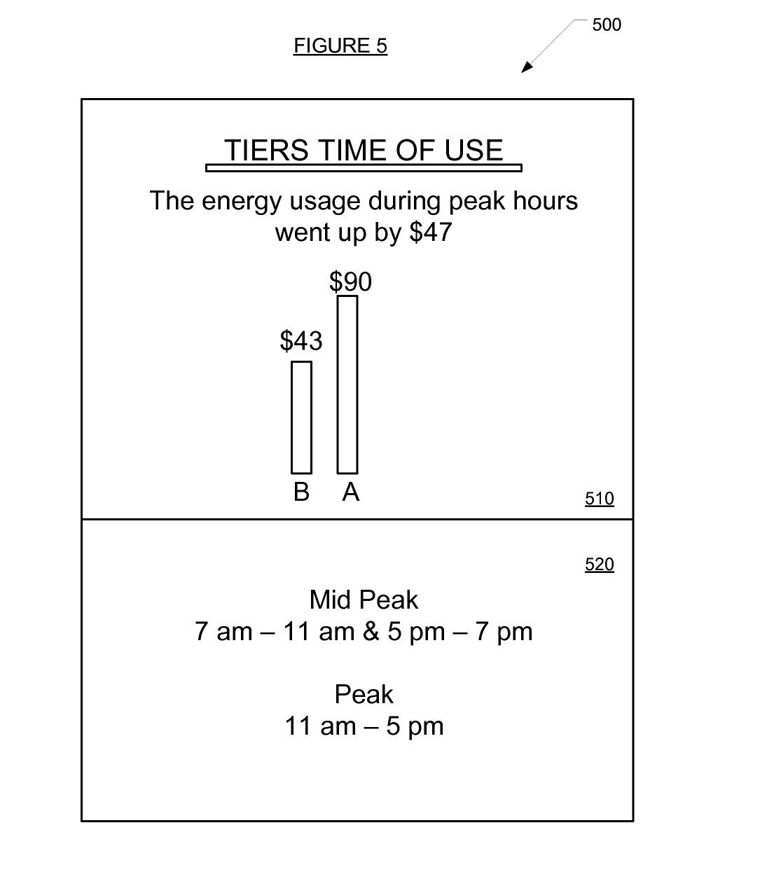

FIG. 5 may identify changes in peak time usage between the periods A and B at 500. This information may explain the increased costs for customers with TOU rate plans. At 510 the customer may be graphically presented with information indicating that in Period A peak usage resulted in $90 of charges, while in Period B peak usage only cost $43. The customer may be informed that “The energy usage during peak hours went up by $47.” The customer may also be reminded at 520 of the breakdown of peak and mid-peak time periods in which costs may be greater than non-peak or non-mid-peak times.

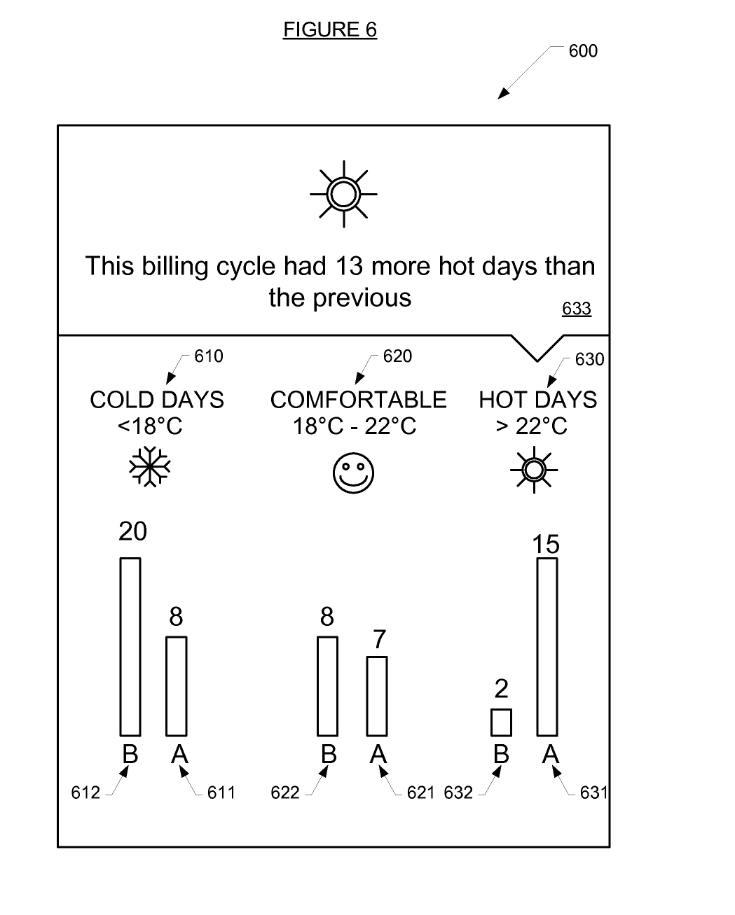

FIG. 6 illustrates a graphic 600 that may identify changes in weather between two periods, which may have caused the higher energy bill. The graphic 600 may inform the customer of the amount of cold days 610, comfortable days 620, and hot days 630 in the present period. Each of these categories may be compared with the previous period. It can be seen that Period A had eight (8) cold days at 611, while Period B had twenty (20) cold days at 612. Similarly, Period A had seven (7) comfortable days at 621, while Period B had eight (8) comfortable days at 622. Notably, Period A had fifteen (15) hot days at 631 while Period B had only two (2) hot days at 632. The relevant portion may be highlighted for the customer at 633, stating “This billing cycle had 13 more hot days than the previous.”

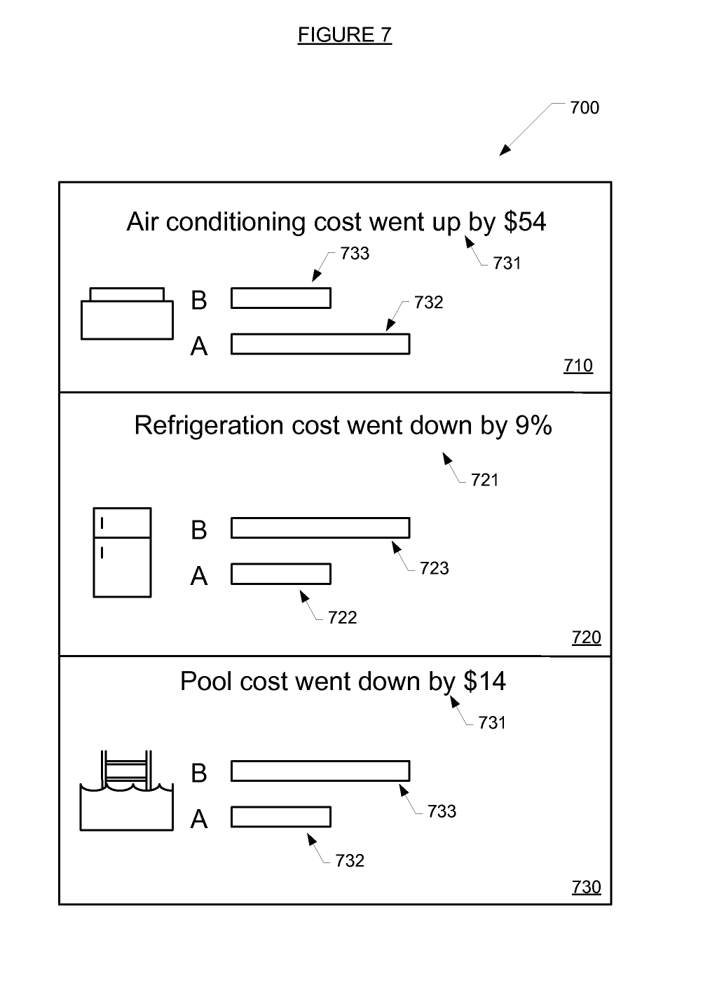

FIG. 7 may set forth disaggregated data 700 to assist in identifying specific appliances that may be the reason for, or contribute to the high bill. At 710 information regarding the air condition may be presented, while 720 is directed to the refrigerator and 730 is directed at the pool pump. Disaggregated data relevant to the air conditioner may be summarized at 711 (“Air Conditioning cost went up by $54”), while comparisons between the current period (Period A, 712) and the previous period (Period B, 713) may be presented.

Disaggregated data relevant to the refrigerator may be summarized at 721 (“Refrigeration cost went down by 9%”), while comparisons between the current period (Period A, 722) and the previous period (Period B, 723) may be presented. Note that comparisons, increases, or decreases may be presented as dollar amounts, energy units (kWh), or percent changes.

Disaggregated data relevant to the pool pump may be summarized at 731 (“Pool cost wend down by $14”), while comparisons between the current period (Period A, 732) and the previous period (Period B, 733) may be presented.

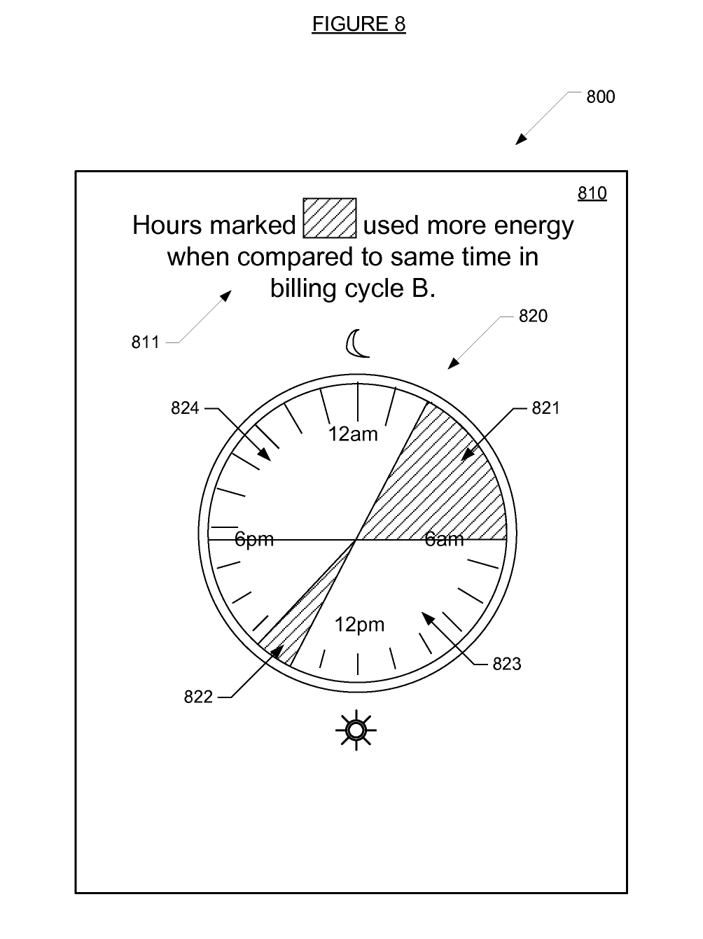

FIG. 8 may generally present a customer with a graphic 800 identifying specific hours within an average day that the current period exceeded usage from the previous period. The customer may be informed at 811 that “Hours marked used more energy when compared to the same time in billing cycle B.” Such graphic may be in the form of a clock 820 (which may be a twelve or twenty-four hour clock) with hours marked when the customer used more energy when previously. Hours of increased usage are indicated at 821 and 822. No increase is indicated at 823 and 824.

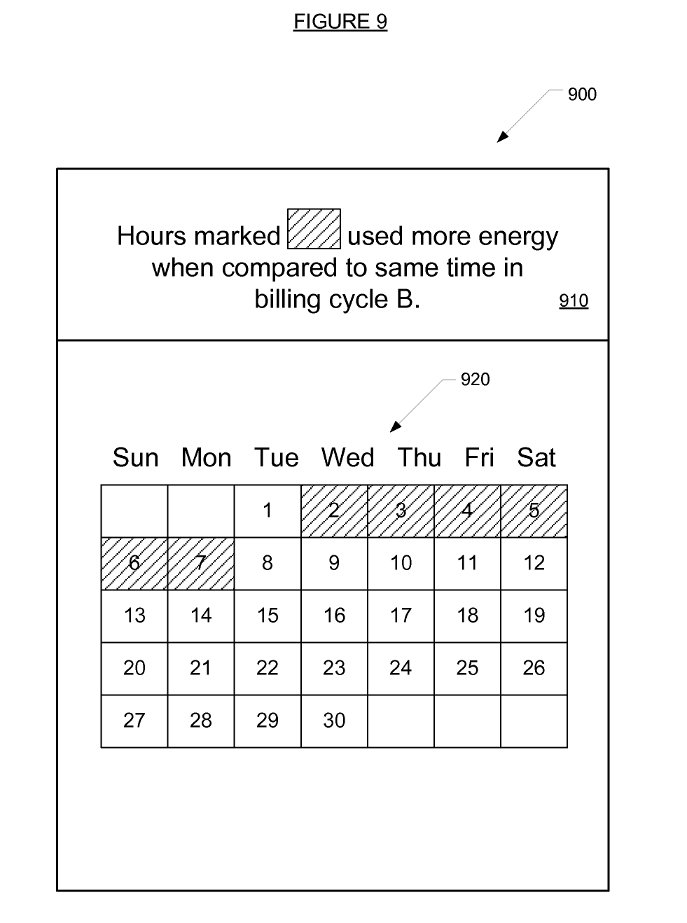

FIG. 9 may present a customer with information 900 illustrating increased usage on days, when compared to the previous period. The customer may be informed that “Days marked used more energy when compared to the same days in billing cycle B” at 910. A calendar 920 or other graphic may be used to visually present the information to the customer. With continued reference to FIG. 9, it can be seen that days marked with hatching used more energy when compared to same days in billing cycle B.

The present disclosure is directed to systems and methods for providing detailed energy usage data comprising disaggregation results to a customer service representative. More specifically, devices in accordance with some embodiments of the present invention may access a database containing a customer's energy usage data. Alternatively, an energy management device may receive real-time or near real-time streaming data regarding a customer's usage. Personalized recommendations (e.g. ways to save money, change behavior, propose new energy efficient appliances, participate in any relevant utility rebate programs, etc.) may be determined, and such recommendations may be presented either to an agent or customer service representative may then share this information, or shared directly with the customer. Such recommendations may be based on any number of factors, including but not limited to the specific user's disaggregated energy profile, the address of the user, the usage level of the user, and/or available programs from the applicable utility.

A description of an embodiment with several components in communication with each other does not imply that all such components are required. On the contrary a variety of optional components are described to illustrate the wide variety of possible embodiments of the invention. When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for managing energy usage in a household, the method comprising:
receiving, using an energy management device, entire energy profile data associated with the household generated in a first time period;
disaggregating, using the energy management device, the entire energy profile data to determine energy usage associated with one or more appliances used in the household;
retrieving, using the energy management device, energy usage of the household generated in a second time period;
detecting, using the energy management device, one or more deviations in the disaggregated energy data generated in the first time period based on the energy data of the household generated in the second time period;
identifying, using the energy management device, one or more causes of the one or more deviations.

2. The method of claim 1, wherein the identifying is based on at least in part on a change in an applicable energy usage rate structure or energy tier limits.

3. The method of claim 1, wherein the identifying is based at least in part on a determination that more energy was used during peak time period.

4. The method of claim 1, wherein the identifying is based at least in part on at least one parameter associated with one or more appliances, increased energy usage on specific days in the first time period, change in weather, or increased energy usage on specific days in the first time period.

5. The method of claim 1, wherein identifying one or more causes of the one or more deviations comprises:
determining a proportional amount of increase, if any, in the energy usage cost based at least in part on comparing energy usage cost for the first time period with energy usage cost for the second time period;
determining a proportional amount of increase, if any, in the amount of energy usage based at least in part on comparing energy usage in the first time period with energy usage in the second time period;
identifying increase in the energy usage as the cause for the one more deviations when the proportional amount of increase is same, substantially the same, or correlated; and
determining that the percentage increase is not same, substantially the same, or correlated; and
identifying the cause for the one more deviations as a change in an applicable energy rate structure or increased energy usage during peak hours.

6. The method of claim 5, further comprising:
determining that there has been no change in the applicable energy rate structure;
comparing energy usage units per cost unit in the first time period with the energy usage units per cost unit in the second time period; and
determining that there are more cost units in top energy tier limits; and
identifying a change in one or more energy tier limits in the first time period as the cause for the one or more deviations.

7. The method of claim 6, further comprising:
determining that there is no change in the one or more energy tier limits in the first time period;
comparing peak energy usage units per cost unit in the first time period with the peak energy usage units per cost unit in the second time period;
determining percentage increase in the peak energy usage units per cost unit; and
identifying the cause for the one or more deviations as increased usage in the peak time period.

8. The method of claim 7, wherein the steps of the comparing and the identifying are repeated for partial-peak or non-peak time periods.

9. The method of claim 5, further comprising:
correlating the increase in the energy usage with weather;
determining it is summer and comparing energy usage units in the first time period with energy usage units in cooling degree days (CDD); and
identifying the cause for the one more deviations as the weather.

10. The method of claim 4, further comprising:
comparing increase in energy usage units associated with a specific appliance with increase in energy usage units associated with the one more appliances; and
determining that the increase in energy usage units associated with one appliance matches, substantially matches, or correlates with increase in energy usage units associated with the one more appliances;
identifying the specific appliance as the cause for the one or more deviations in the first time period.

11. The method of claim 1, wherein identifying one or more causes of the one or more deviations comprises:
comparing, for specific hours of a day in the first time period, energy usage cost in the first time period against the energy usage cost in the second time period;
determining that there is an increase in the energy usage cost in the first time period compared with the energy usage cost in the second time period
identifying the cause for the one more deviations as an increase in the energy usage for the specific hours of the day in the first time period.

12. The method of claim 1, wherein identifying one or more causes of the one or more deviations comprises:
comparing, for specific days of the first time period where energy usage is high, energy usage cost in the first time period against the energy usage cost in the second time period;
determining that there is increase in the energy usage cost in the first time period against the energy usage cost in the second time period; and
identifying the cause for the one more deviations as the increase in the energy usage for specific days in the first time period.

13. The method of claim 1, wherein the first time period is current billing cycle.

14. The method of claim 1, wherein the second time period is the previous billing cycle.

15. The method of claim 1, further comprising visually displaying the one or more causes of the one or more deviations on a user terminal.

16. The method of claim 1, wherein the user is guided via a virtual agent displayed on the user terminal to identify the one or more causes of the one or more deviations.

17. The method of claim 4, wherein the at least parameter associated with the one or more appliances comprises a defect in the appliance or high usage of the appliance.

18. The energy management device comprising:
one or more hardware processors;
a memory coupled to the one or more hardware processors storing instructions, that when executed by the one or more hardware processors, causes the one or more hardware processors to perform operations comprising:
receiving, using an energy management device, entire energy profile data associated with the household generated in a first time period;
disaggregating, using the energy management device, the entire energy profile data to determine energy usage associated with one or more appliances used in the household;
retrieving, using the energy management device, energy usage of the household generated in a second time period;
detecting, using the energy management device, one or more deviations in the disaggregated energy data generated in the first time period based on the energy data of the household generated in the second time period;
identifying, using the energy management device, one or more causes of the one or more deviations.

19. The method of claim 18, wherein the identifying is based on at least in part on a change in an applicable energy usage rate structure or energy tier limits.

20. The method of claim 18, wherein the identifying is based at least in part on a determination that more energy was used during peak time period.

21. The method of claim 18, wherein the identifying is based at least in part on at least one parameter associated with one or more appliances, increased energy usage on specific days in the first time period, change in weather, or increased energy usage on specific days in the first time period.
